(19) United States
(12) Patent Application Publication
(10) Pub. No.: US 2024/0305235 A1
(43) Pub. Date: Sep. 12, 2024

(54) SYSTEM AND METHOD FOR PRODUCING HYDROGEN FROM SOLAR ENERGY AND USE THEREOF IN ELECTRICITY PRODUCTION

(71) Applicants: Akhilesh Prasad SINGH, New Delhi (IN); Nimeshee SINGH, New Delhi (IN); Deepitark SINGH, New Delhi (IN)

(72) Inventors: Akhilesh Prasad SINGH, New Delhi (IN); Nimeshee SINGH, New Delhi (IN); Deepitark SINGH, New Delhi (IN)

(21) Appl. No.: 18/039,244

(22) PCT Filed: Sep. 29, 2021
(86) PCT No.: PCT/IB2021/058900

§ 371 Date: May 28, 2023

(30) Foreign Application Priority Data
Dec. 4, 2020 (IN) 202011053001

(51) Int. Cl. H02S 10/20; C25B 1/04; H01M 8/04082; H01M 8/0656; H01M 8/18; H02J 3/28; H02S 20/10; H02S 40/20

(52) U.S. Cl. CPC H02S 10/20; C25B 1/04; H01M 8/04201; H01M 8/0656; H01M 8/186; H02J 3/28; H02S 20/10; H02S 40/20; H02J 2300/26; H02J 2300/30; H02J 2300/40

(57) ABSTRACT

The present invention provides a pole mounted solar energy capturing device for electrical power generation and collection. In the present invention a system has been developed for installation of Solar panels/collector in cultivating lands without affecting the land production of crops/plants. The solar collectors of the present invention are installed in columns in any direction but solar panels always facing toward sun in mid-day for any location on Earth (South or North) managing columns to columns gap equal to total width of panels at single arm on pole. Further the electricity received from the solar panels is provided for water electrolysis and mass production of Hydrogen. The hydrogen produced is stored in chemical form for reuse as and when required at very economical rate and also distributed of hydrogen energy without physical transportation of hydrogen fuel to all energy sectors (moving or stationary) as per the demand.

### FIELD OF INVENTION

The present invention relates to a system and method that produces hydrogen from solar energy and its use thereof in electricity production and distribution for various applications. Particularly, the present invention provides a system for capturing solar energy and utilizing the energy in production, storage, and distribution of Hydrogen for other commercial purposes.

### BACKGROUND OF THE INVENTION

As the farmers provide the world's population with food they are known to play a significant role in our society. Nowadays, farmers not only provide food but their farms are also providing energy, especifically renewable energies. For e.g. energy can be generated from the wind, the sun or the biomass which either they can use it for their own farm, or, if they have in surplus, resell it to electricity board.

Solar energy might be one of the easiest ways for farmers to produce energy. Therefore, the use of solar energy in agriculture is becoming increasingly popular and the energy produced from this renewable source can be used either on the farm or in the local power grid, providing the farmer with an additional income. However, there are various problems encountered while installing a solar panel on a cultivated land.

Firstly, the ground mounted solar arrays often require a large area for installation and are also subjected to shading, soiling and, in some locales, seasonal snow cover.

Secondly, there is limitation in the width and height of solar panels and shading on ground caused due its installation. Usually, at least 20% of sunlight is absorbed or used by green plants through cellular respiration for photosynthesis. In case of shading caused by installation of solar panels sunlight is restricted which in turn hinders the photosynthesis process in plants thereby decreasing plants growth.

Thirdly, sunlight is very valuable for farming and plant growth, however, in the rainy season when the sky is mostly covered by clouds the plants fail to receive adequate sunlight.

Further, even today when the renewable energies have been explored to a great extent the world faces energy crisis. Sunlight though being available in abundance could not be utilized to its maximum capacity due to limitations in the installation of the solar panels/collectors. Further, limitation of solar energy is mass energy storage system. Batteries, super capacitors, potential energy etc. are utilized to store solar energy however, their storage capacity is not that sufficient. Moreover, the batteries need high maintenance.

There are many ways for hydrogen production using fossil fuels, but all are very expensive. Other resources based Hydrogen production is either expensive or very small in quantity. GHG emissions & many more disadvantages with limitations in existing technical setups are forcing to use of limited fossil fuels to fulfill energy demands of all sectors.

At present high cost Hydrogen as fuel is used in road vehicles with large storage tank, fuel cells and other accessories for limited driving. The operating cost of Hydrogen fuel based vehicles in existing technologies are very high due to use of very expensive hydrogen fuel produced by existing technologies with addition cost of maintenance charges as onboard fuel cells having very low life span like 7000-8000 hours only and costly to replace. Limitations in transportation of costly hydrogen to refueling station, costly hydrogen kit on each vehicle, limited driving, cost etc. makes it an alternative of other energy sources.

In view of the above drawbacks there is a need for a system that provides efficient utilization of the sunlight i.e., generates maximum solar energy and also stores the solar energy in abundance as hydrogen to utilize the same when the sun is not available.

### OBJECTIVE OF THE INVENTION

The primary objective of the present invention is to provide a system and method that produces hydrogen from solar energy and further utilizes it in electricity production and distribution for various applications.

Yet another objective of the present invention is to provide a pole mounted solar energy capturing system

Yet another objective of the present invention is to provide a pole mounted solar energy capturing system in columns for any direction for generating maximum electrical energy from available land area.

Another objective of the present invention is to provide a pole mounted solar energy capturing system for storing maximum electrical energy developed.

Yet another objective of the present invention is to provide easy installation of solar panel/collector nearby to end users in order to save transmission and distribution losses.

Yet another objective of the present invention is to provide mass electricity generation by solar panels and its storage in form of chemical energy for example as Hydrogen at 700 bar pressures at ambient temperature or as per location climatic condition.

Another objective of the present invention is distribution of Hydrogen for generating electrical energy and supplying to electric road network and national grid for usage as per the demand of the consumer.

Yet another objective of present invention is distribution of hydrogen energy to all sectors (moving or stationary) without physical transportation of Hydrogen.

Yet another objective of the present invention is to provide green energy generation and economical energy storage as hydrogen for global utilization.

Other objectives and advantages of the present invention will become apparent from the following description taken in connection with the accompanying drawings, wherein, by way of illustration and example, the aspects of the present invention are disclosed.

### SUMMARY OF THE INVENTION

The present invention relates to a system and method that produces hydrogen from solar energy and further utilizes it in electricity production and distribution for various applications. In the present invention a system has been developed for installation of Solar panels/collectors in cultivating lands without affecting the land production of crops/plants. The system installation in cultivating/farming lands facilitates dual benefits to farmers like cultivation/cropping/farming/plantations as usual and solar electricity from solar panels/collectors mounted on poles. The solar panels/collectors provide additional energy for better growth/development of plants resulting in more production than normal as well as electricity generation. The solar collectors of the present invention are installed in columns in any direction but always facing with tilts as per attitude of location (South or North) and columns to column gap managed equal to width of panels/collectors along with on pole in transverse direction of columns. Further, to manage negligible shadow effects on plantations, solar collectors are installed at certain height and distance between poles enough for cultivation and movement of agricultural machines as usual for farming and generation of electricity. The system also incorporates LED's installed at the back of the Solar Collector to facilitate luminance of suitable wavelength to the crops installed below the solar collector to promote photosynthesis process in case of shading or unavailability of sunlight extended light period for crop needs. Furthermore, the system also incorporates water sprinkler for regular cleaning the solar collectors for better solar energy outputs and the plants nearby to absorb maximum sunlight as per requirement. Also considering valuable advantages of Hydrogen, in the present invention electricity received from the solar panels is provided for water electrolysis and mass production of Hydrogen. The hydrogen produced is stored for reusing it, as and when required for example production of energy at very economical rate and also distribution to all energy sectors as per the demand.

### BRIEF DESCRIPTION OF DRAWINGS

The present invention will be better understood after reading the following detailed description of the presently preferred aspects thereof with reference to the appended drawings, in which the features, other aspects and advantages of certain exemplary embodiments of the invention will be more apparent from the accompanying drawing in which:

FIG. 1 illustrates the block diagram of the system of the present invention.

FIG. 2 illustrates connection of the plurality of twin cells solar panel at the pole to avoid voltage drop in extended sun time period i.e., early morning or late evening.

FIG. 3 illustrates the perspective view of the pole mounted solar capturing system installed in columns maintaining specified gap.

FIG. 4 illustrates system model wherein fifty four solar capturing system (panels) are installed at nine poles in three columns with three poles in each columns format.

FIG. 5 illustrates the perspective view of two pole mounted solar capturing system installed in column back side of front pole maintaining faces of solar panels always towards sun in mid-day at the location.

FIG. 6 illustrates poles and solar Panels in a column with 60° tilts of solar panels for New Delhi with sun light at 180° azimuth on Equinox position of Sun.

FIG. 7 illustrates solar path at New Delhi for 20-march-2021 and variation of solar path for whole year.

FIG. 8 illustrates the flow diagram of distribution of Solar energy through the system of the present invention to various sectors.

Table 1-4 illustrates Shadow length and its length in South North Direction and East-West Directions for justifying spaces.

Reference Numeral for the system (100) for storage of solar energy as hydrogen of the present invention:

| | | Reference |
|---|---|---|
| S. No. | Component | Numeral |
| 1. | Solar Energy Capturing System | 101 |
| 2. | Power Distribution and Management (PDM) panel | 102 |
| 3. | DC/AC Convertor | 103 |
| 4. | Transformer | 104 |
| 5. | Grid | 105 |
| 6. | Oxygen Storage Tank (106): | 106 |
| 7. | DC/DC inverter | 107 |
| 8. | Hydrogen Gas Storage Tank | 108 |
| 9. | A monitoring and control system | 109 |
| 10. | Electric Road Network | 110 |
| 11. | Electrolyser | 111 |
| 12. | Water Pump | 112 |
| 13. | Water Tank | 113 |
| 14. | Fuel Cells | 114 |
| 15. | Fuel Cells Power Panel | 116 |

Reference Numeral for solar capturing system (101, 200):

| S. No. | Components | Reference Numerals |
|---|---|---|
| 1. | one pole | 201 |
| 2. | pole top | 202 |
| 3. | a top horizontal beam | 203 |
| 4. | a plurality of panel support frame | 204 |
| 5. | solar collectors | 205 |

### DETAILED DESCRIPTION OF THE INVENTION

The following detailed description and embodiments set forth herein below are merely exemplary out of the wide variety and arrangement of instructions which can be employed with the present invention. The present invention may be embodied in other specific forms without departing from the spirit or essential characteristics thereof. All the features disclosed in this specification may be replaced by similar other or alternative features performing similar or same or equivalent purposes. Thus, unless expressly stated otherwise, they all are within the scope of the present invention.

Accordingly, those of ordinary skill in the art will recognize that various changes and modifications of the embodiments described herein can be made without departing from the scope of the invention. In addition, descriptions of well-known functions and constructions are omitted for clarity and conciseness.

The terms and words used in the following description and claims are not limited to the bibliographical meanings but are merely used to enable a clear and consistent understanding of the invention. Accordingly, it should be apparent to those skilled in the art that the following description of exemplary embodiments of the present invention are provided for illustration purpose only and not for the purpose of limiting the invention.

It is to be understood that the singular forms “a”, “an” and “the” include plural referents unless the context clearly dictates otherwise.

It should be emphasized that the term “comprises/comprising” when used in this specification is taken to specify the presence of stated features, integers, steps, or components but does not preclude the presence or addition of one or more other features, integers, steps, components, or groups thereof.

It should be understood that the present invention is specifically directed towards the implementation of the technology in three wheeler electric vehicles however, the technology can also be implemented in other types of hybrid or non-hybrid electric vehicles.

In the present invention relates to a system and method that produces hydrogen from solar energy and further utilizes it in electricity production and distribution for various applications. In the present invention a system has been developed for installation of Solar panels/collector in cultivating lands without affecting the land production of crops/plants. This technology facilitates easy solar panel installation nearby to end users saving transmission and distribution losses. The system makes the land more useful and beneficial. The major benefits are cultivation of land, generation of electricity, no scarcity of land by combining cultivating lands along with unused lands/hilly terrain for large capacity solar plants near residential or Industrial area, easy availability, and avoiding transportation of hydrogen fuel to major fuel using sectors and large energy generation in day time from solar energy.

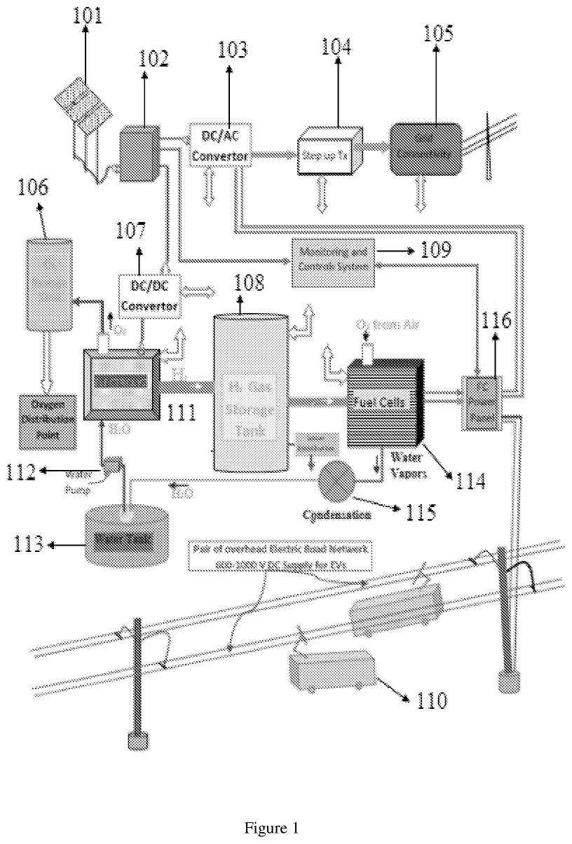

FIG. 1 of the present invention illustrates a block diagram of the system of the present invention. The various components of the present invention are discussed here in detail:

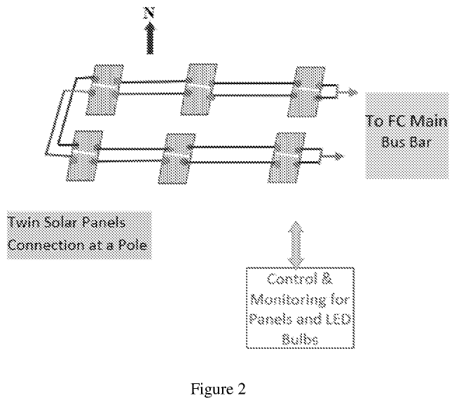

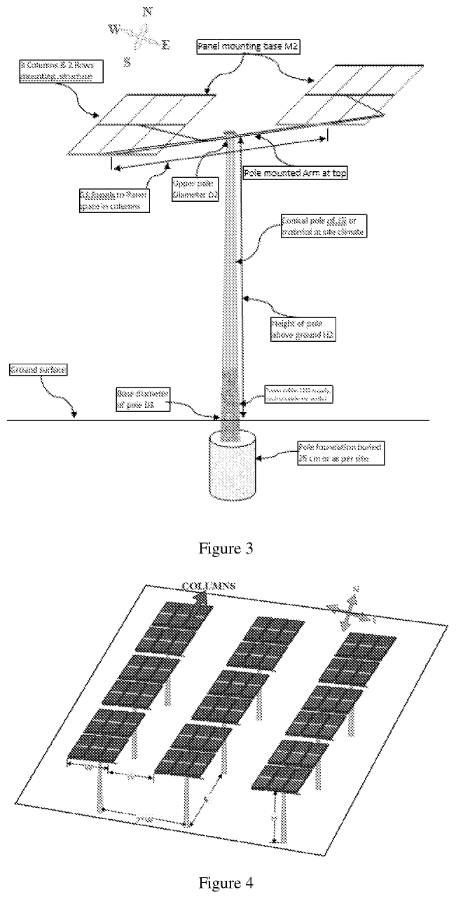

(a) Solar Energy Capturing System (101): In the present invention solar collectors (also referred as solar panels) are installed in columns in any direction as per land availability but always facing towards sun in mid-day time (South or North as per location) and maintained columns to column transverse space equal to total width of panels alongside on pole. To manage negligible shadow effects on plantations, solar collectors are installed at certain height and distance between poles enough for cultivation and movement of agricultural machines as usual for farming and generation of electricity. FIG. 2 of the present invention illustrates the connection between the solar collectors.

FIG. 3 shows one exemplary pole mounted solar capturing system (101, 200). System (200) includes one pole (201) having pole top (202), a top horizontal beam (203), and a plurality of panel support frame (204) that are mounted on top horizontal beams. As shown, top horizontal beam (203) is mounted on the pole (201) and is supported in between with the pole top (202) and is substantially horizontal. Each panel support frame (204) may support one or more solar collectors (205) converting sunlight into electrical energy at any location.

The plurality of panel support frame (204) is made of Stainless steel/Aluminum/Galvalume/Steel/HDG/CFS and are rectangular/circular in shape as per location specification. They are mounted on top horizontal beams by clamping bottom beam. The front frame of the panel support (sun facing direction) is clamped at end of top horizontal beam attached with pole and back side frame mounted at length of shading at location. Middle beams are supported by beams mounted on horizontal beam at mid or extended at direction of tilt of panels at locations for stability.

Poles (201) may be made of Stainless steel/Aluminum/Galvalume/Steel/HDG/CFS of thickness as per location climatic conditions (approximately 15-20 mm thickness pipe is used). In an embodiment, poles (201) are conical in shape and having Base Diameter (206) and Top Diameter (207). The poles (201) may be mounted by partial burial in the ground, with or without concrete (or other such material) for support. In an example the pole foundation is one foot below ground surface having 12 inches diameter. The conical pole has a height 3.5 m for mounting solar collectors (205). Top horizontal beam (203) may be made from one or more of Stainless steel/Aluminum/Galvalume/Steel/HDG/CFS as per acceptable specification at location. Top horizontal beam (203) may be a circular or rectangular rod having an “I” cross section and may be hollow from inside. Further, top horizontal beam (203) may also provide incorporation of electrical busses and connectors. Top horizontal beam (203) may be formed with one or more holes or clamping of bottom beam of frame at middle position to allow panel support frame (204) to be attached therefrom.

Panel support frame (204) may be formed of Stainless steel/Aluminum/Galvalume/Steel/HDG/CFS acceptable standard at location. In one embodiment, panel support plates are designed in. rectangular shape of length equal to panel and width to sum of panels width alongside at pole of size as per site requirement

As shown in FIG. 4 the system (200) may be oriented such that solar collectors or panels (205) face an optimal direction for harvesting solar radiation throughout the year. For example, system (200) may be oriented to mount solar collectors (205) to face South in Northern hemisphere and North in Southern hemisphere for columns in any direction but facing are always same for location. As known in solar harvesting technology, the optimal direction for solar harvesting is based upon location on the earth's surface with tilt of panels equal to altitude of sun at midday in equinox path. Further it also shows a top view of Solar panels being installed on pole in cultivating/Forming or any land areas without shading effect. North South component of poles and panels in any direction will be maximum at sun on 180° Azimuth and optimized at equinox path of sun. The poles to pole distance in columns in any direction is maintained atleast above shown in fig for North to South while East to west direction varies as per direction of columns along with shadow length.

FIG. 4 shows the exemplary system model wherein fifty four solar capturing system (panels) are installed at nine poles in three columns with three poles in each columns format, system (200) may include more or fewer poles in columns or more columns may be added as per site power demand, without departing from the scope thereof.

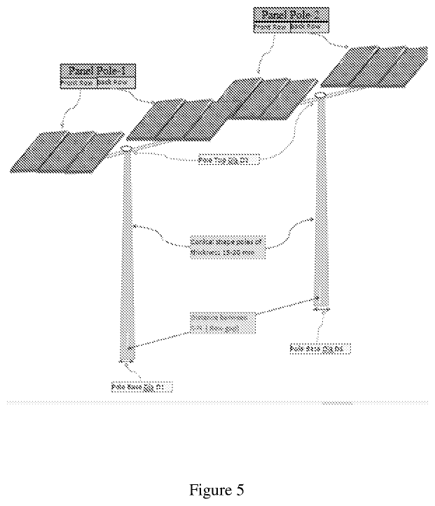

FIG. 5 shows two exemplary poles mounted in columns with 6 solar panels on each with three one side and three other side facing towards sun at mid-day for location where panel support frame (204) is attached to horizontal beam (206) of system (200). The bottom beam of frame either screwed or clamped at middle position at end of horizontal bean for front panels and at specified no shading length for back frame mounted in similar way. The size dependents on locations and specification acceptable. Middle beam of frame supported from back side by another beam from horizontal beam including extended part of horizontal beam backside.

The solar collector (205) has a plurality of solar cells that are interconnected through electrical contacts that attach to power leads, respectively. In yet another embodiment, solar collector (205) includes electronics or embedded electronics, for example, one or more microinverters, Maximum Power Point Tracking (MPPT) components, DC to DC inverters, power optimizers, etc. Panel support frame (204) and solar collector (205) are mounted vertically from horizontal beam (206) and may pivot at least partially around beam (206) when blown by prevailing winds. All top part of twin panels at a pole are connected in series as well as all lower panels and combined in parallel to main bus bas. Similarly, all panels on each pole are connected in series and parallel to main bus bar.

In an alternate embodiment, horizontal beams may include electrical connectivity to facilitate connection of solar collectors. As shown in diagram of electrical connection of panels, all outputs are connected to main supply bus bar as main cable laid underground minimum 50 cm along with control and other power cables from Fuel cells as per capacity of solar plant at particular location.

In an embodiment Light Emitting Diodes (for e.g., 7000 k temperature) (LEDs) are mounted on back side of solar collector for emitting illuminance for suitable time period and wavelength depending upon the requirement of the plant sowed under the solar collector. LED light is somehow similar to sunlight though having low lumens. For example, about 5-25 watts LED bulbs shall be sufficient in providing illuminance in case of shading or cloudy day. Further the vertical light from LED light on plants would reach much deeper for better growth of plants.

Further to increase growth and production of plants water sprinkler/sprayer is utilized. For e.g., cocktail water pump is mounted on the top pole (102) to sprinkle water on solar panels as well as trees, plants nearby to enhance energy capturing capacity.

In an exemplary embodiment the solar collectors output are highly affected by size, width, location altitude, type of land etc. are installed in the field based on the calculation elaborated herein:
i. Solar Panel size (Length, width, thickness): L*w*t
ii. Altitude for sun at mid day time in equinox path at location: A°
iii. Vertical Tilt of Solar panels at locations: A°
iv. Altitude of sun and azimuth at location at any time: A & Az
v. Horizontal component of mounted Solar panel: L×Sin (A°)
vi. Height of mounted Panel: L×Cos (A)=h

$$vii . Shadow of object of height h ( South - North Direction ) = \frac{h}{Tan A °}$$

viii. Normal gap between two panels (South to North): Shadow of panel in north direction for Northern and South for southern hemisphere at sun altitude A°

$$ix . Shadow of Panel ( height after mount ) in north or south : \frac{h}{Tan A °} \\ x . Shadow of panel height h at sun altitude of location \& time = \frac{h}{tan A}$$

In an exemplary embodiment of the present invention Specification of Pole:
i. Height: 3.5 M (Normal)
ii. Columns panel to panel gap (East-West) direction: panel shadow length at pole height for acceptable altitude of sun (Time in morning and evening)=total width of panels alongside=3×w (for three panel in row)=W
iii. Transverse gap between Column panel to panel=W (min)
iv. Poles to pole (South-North) gap=Minimum 2×(horizontal length of panel+shadow of panel). I can be optimized for around year for optimum energy output.

### Solar Panel Conical Pole Specification for 150-200 km Wind Speed:

i. Base Diameter: 2″ per panel at pole (For 6 panels 12″ or 30.5 cm)
ii. Top Diameter: 1.5″ per panel at pole (For 6 panels 9″ or 22.9 cm)
iii. Thickness: 15-20 mm depending on location, wind speed, weight of solar panels
iv. Height above surface: 3.5 M or as per site climatic condition
v. Pole foundation: 30 cm below surface
   Top panel mounting support of length as per gap between two rows on same pole tilted according to location altitude in South-North direction.

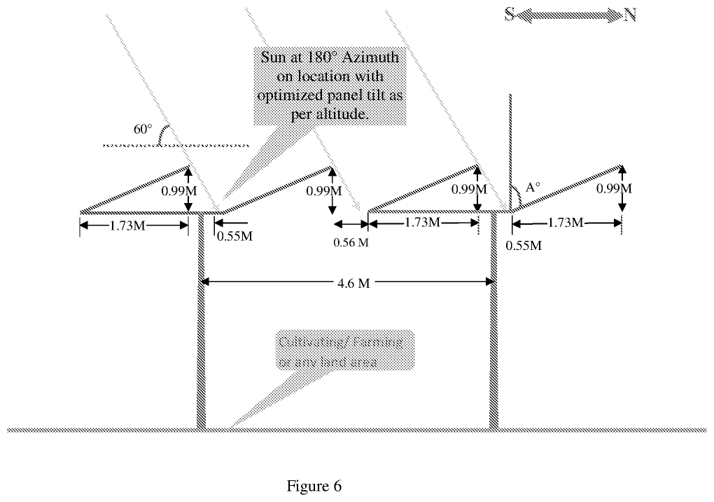

FIG. 6 illustrates poles and solar panels in a column with tilt of solar panels for New Delhi with sun light at 180° on Equinox position of Sun.

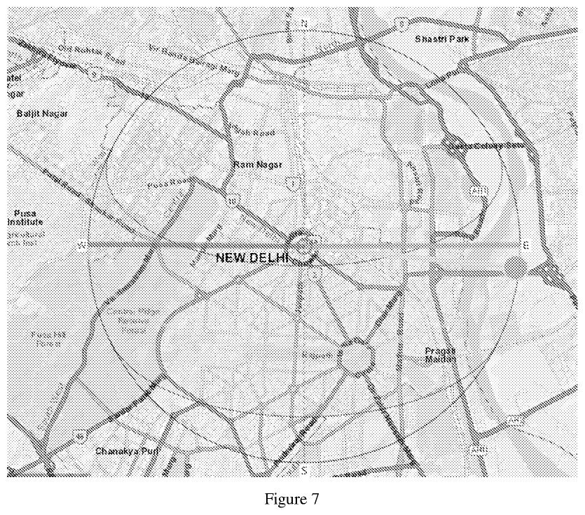

FIG. 7 illustrates Solar Path at New Delhi for 20 Mar. 2021 and variation of solar path for whole year.

### Example: Technical Setup & Specification at Location New Delhi INDIA

| S. No. | Parameters | Reading | |
|---|---|---|---|
| 1. | On 20th March (Equinox) | | |
| | Latitude: | 28.63° | |
| | Longitude: | 77.21° | |
| 2. | Altitude of Sun at 180° Azimuth at 20 March | 61° | |
| | Equinox | | |
| 3. | Optimized Tilt of solar Panel New Delhi India | 60° towards North (for | |
| | | whole year) | |
| 4. | Conical Pole height | 3.5M (general land area) | |
| 5. | Twin Solar Panels: | | |
| | L= | 1.987M | |
| | W= | 0.99M | |
| | t= | 5 | mm |
| | Power: | 500 | Wp |

| | | |
|---|---|---|
| 6. | Horizontal length of mounted solar panel (1): | 1.73M |
| 7. | Height of mounted solar panel (h): | 0.99M |
| 8. | Combined width of 3 panels: | 3M (optimized) |
| 9. | South-North Gap among panels (High and low) | 0.55M (optimized) |
| 10. | Columns space East-West direction | 3M |
| 11. | Length of Cell with single pole (6 Panels): | 4.6M |
| 12. | Width of Cell with one pole (3 Panels in row) | 3M |
| 13. | Area of a Cell | 13.8M² |
| 14 | Total Solar Panel Area | 13.8 * Nos. of Cells |
| | | columns * Cell rows |
| 15. | Total Power output | 6 * power of single panel* |
| | | (Colomns − 1)/2 * Nos. Rows |

For 3 Rows & 7 Columns with solar panel of capacity 0.5 kW for example:

| | |
|---|---|
| Total Power | 6* 0.5 * (7 − 1)/2*3 = 27 kW |
| Land Area | 13.8 * (No of total cells) = |
| | 13.8*21 = 290M2 |
| Land Area per kW Power | 290/27 = 10.75M² |

Table 1-4 illustrates Shadow length and its length in South North Direction and East-West Directions for justifying spaces.

(b) Power Distribution and Management (PDM) panel (102): It is an electrical supply distribution system that divides an electrical power feed into subsidiary circuits. In the present invention the solar power received from the solar collector is feeded to the electrical panel which is further distributed based on the requirement. One of the distributions includes supplying power to the DC/AC convertor and another distribution point includes DC/DC Convertor. Power Distribution and Management (PDM) panel balances energy flow according to inputs and demands. In an exemplary embodiment the panel has but not limited to three inputs i.e.,
600-1000 V DC main supply input from solar panels.
600-1000 V DC supply from Hydrogen Fuel cells
An emergency 600-1000 V DC input from AC to DC Invertors powered by Grid Supply.

Further the panel also has but not limited to three main outputs
600-1000 V DC supply to DC to DC Convertor for Electrolysers.
600-1000 V DC to DC to AC Invertors for energy supply to Grid.
600-1000 V DC supply Regulator of Electric Road Network.

The power is also distributed to but not limited to other essential supply terminal for all local electricity supply including control & monitoring, LED Lights on panels, Pump motors, compressors, lighting etc. is maintained using fuel cells for uninterrupted supply. The method for distribution and management of energy from PDM panel comprises the following steps:
(i) distributing the energy generated from the solar collectors (101) of approximately ⅔ part of the generated electricity to electrolyser (111) for producing hydrogen and ⅓ of the generated electricity or access of energy to Grid Supply (105) and Electric Road Network (110).
(ii) managing the electricity demand required by the electrolyser (111) to produce Hydrogen.
(iii) utilizing energy generated from hydrogen fuel cells for distribution to Electric Road Network or Grid Supply in case the energy generated from the solar panel is not sufficient or even when solar energy is not available.
(iv)supplying the energy generated from solar power to Electric Road Network (110) and National Grid Supply (105) after sufficient production of hydrogen.

(c) DC/AC Convertor (103): The direct current received from the electrical panel (102) is converted to alternating current and feeded to Step Up Transformer (104) for further distribution.

(d) Transformer (104): The alternating current received from the DC/AC Convertor (103) is stepped up to match the supply in busbars of the Grid. The Step up Transformer design is considered in such a way that it could work bidirectional as step down transformer in case of overloading at plant on high energy demand from Electric Road Network due to heavy EVs traffic nearby. DC to AC inverter supplying power to to Grid Supply will be switched OFF and AC power (600-1000V) will be activated to meet the energy demand of Electric Road Network of local areas as AC supply and AC to DC invertors for electrolyser (111) supply for production of hydrogen gas so that combined output fuel cells and solar panels could meet Electric Road Network demand and additional energy as per pant capacity feed to National Grid.

(e) Grid (105): The stepped up power supply is further distributed to grid for consumption as per requirement in the various sectors.

(f) DC/DC Inverter (107): The power feeded to the electrical panel (102) is distributed to direct current to direct current inverter (107). The inverter further supplies the obtained direct current to an Electrolyser (111). DC to DC inverters maintain 1.23-1.25 V DC supply connected nearby the electrolyser (111) by bus bars for supplying high current carrying capacity.

(g) Electrolyser (111): Electrolysis of water/sea water requires electricity to decompose water molecules into hydrogen molecules and oxygen molecules. The electricity in the present invention is supplied by the Solar Collector (101). The electrolyser receives water from the water tank (113) for electrolysis. Further, the electrolysis reaction of water is carried out by electricity through electrodes (Cathode & Anode). The electrolyte is selected from the group of but not limited to Alkaline electrolyte, Proton Exchange Membrane Electrolyte, Solid Oxide Electrolyte etc. for the electrolysis of the water. The reaction equation is

$${H}_{2} O + Electric Energy \to 1 / 2 {O}_{2} + {H}_{2}$$

The energy required for removal of an electron from Hydrogen on reaction is 2.14*10⁻¹⁸ Joules and a kg Hydrogen contains 3.34*1025 molecules so 39 kWh electricity is required for 100% efficiency. Electrolyser and 1 kg Hydrogen contains 33.3 kWh useable electric energy. Practically at present electrolyzers need 50-70 kWh energy for production of 1 kg Hydrogen due to low efficiency of Electrolyser. The 50-70 units electricity consumption at present rate for 1 kg hydrogen make it very expensive while the present invention overcomes this drawback.

Production of 1 kg Hydrogen by electrolysis need 8.9 kg water/seawater which generate 8 kg pure Oxygen as by product. Pure oxygen can be used for medical treatments or commercial use. Efficiency of electrolyser increases with temperature of water

In water Electrolysis anode potential of 1.23 V is required to decompose water to free Oxygen gas and 4 electrons as per equation: 2H₂O (liquid)=O₂+4 Eo+H+(aq).

(h) Oxygen Storage Tank (106): Oxygen generated while electrolysis of water is store separately in oxygen storage tank. The oxygen from the electrolyser (111) is transferred via a gas pipe to tank and delivered from outlet as per requirement. Quantity of Oxygen to be stored shall be monitored and controlled by monitoring and control system (109) i.e. to control whether to release excess oxygen produced in air or to store in oxygen tank if needed.

(i) Hydrogen Gas Storage Tank (108): The hydrogen generated from the electrolysis of water is stored in the Hydrogen Gas Tank by compressing it through a compressor. The Hydrogen is further distributed to various commercial sectors as per the requirement. The hydrogen is also supplied to the Hydrogen fuel cells (114) for the generation of the electricity. In an exemplary embodiment of the present invention, hydrogen produced by electrolyser (111) are compressed to 700 bar at ambient temperature or as per site requirement using compressor powered by solar electricity and stored in safe underground/above surface/both type storage tank covered with additional outer layer of 6″ gap for water fill up with outlet high in atmosphere for safety from any leakage or as per site requirement ensuring proper safety and security from any unwanted incidence without any extra expenditure on storage except one time infrastructure investment. Typically, 43 kg Hydrogen gas at 700 bar ambient temperature (25° C.) in 1 m³ while 0.09 kg need 5 m³ volume at normal pressure and temperature. Therefore, according to a storage capacity tank a sufficient emergency quantity of gas as per site requirement is developed with safety and security protocols.

(j) Fuel Cells (114): In the present invention Fuel Cells are arranged to generate 600-1000 V DC supply and current as per plant capacity or site conditions. The fuel cells may be selected from the group of but not limited to Alkali fuel cells, Molten Carbonate Fuel Cells, Phosphoric Acid Fuel Cells, Proton Exchange Membrane Fuel Cells, Solid Oxide Fuel Cells etc. The hydrogen to the fuel cells is supplied from hydrogen storage tank (108) and the oxygen is received from the atmosphere for electrochemical production of the electricity. The water is received as a byproduct of the electrochemical process. The warm water from fuel cells via Condenser (115) is stored in the water tank (113). The water requirement of electrolyser (111) is fulfilled by water output from fuel cells. The water received from the fuel cells (114) is purified by the water purifiers and then stored in the water tank (113).

(k) Water Tank (113): The water received from the fuel cells is transferred to the water tank.

(l) Water Pump (112): The water stored in the water tank is pumped using power from solar panels or hydrogen fuel cells as per the requirement.

(m) Fuel Cells Power Panel (116): The output of fuel cells is connected to Power Distribution and Management (PDM) Panel which distribute electricity to different sectors as per electricity demand. Stationary Fuel Cells are generally kept in ON conditions and power output is monitored and managed for feeding amount of Hydrogen to Fuel Cells

(n) A monitoring and control system (109): It is to monitor and manage the distribution of hydrogen through the fuel cells.

(o) Electric Road Network (110): Electric Road Network is electrification of road network of a city or country to power electricity for operating Electric vehicles as Zero emissions road transportation system.

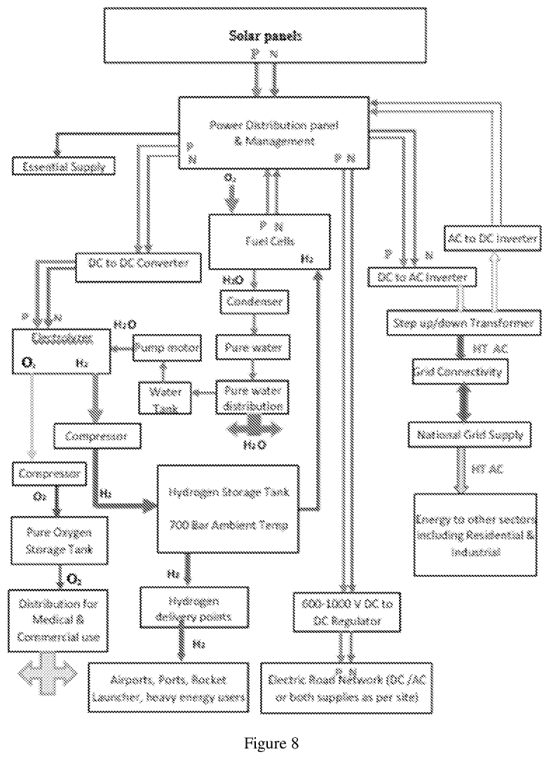

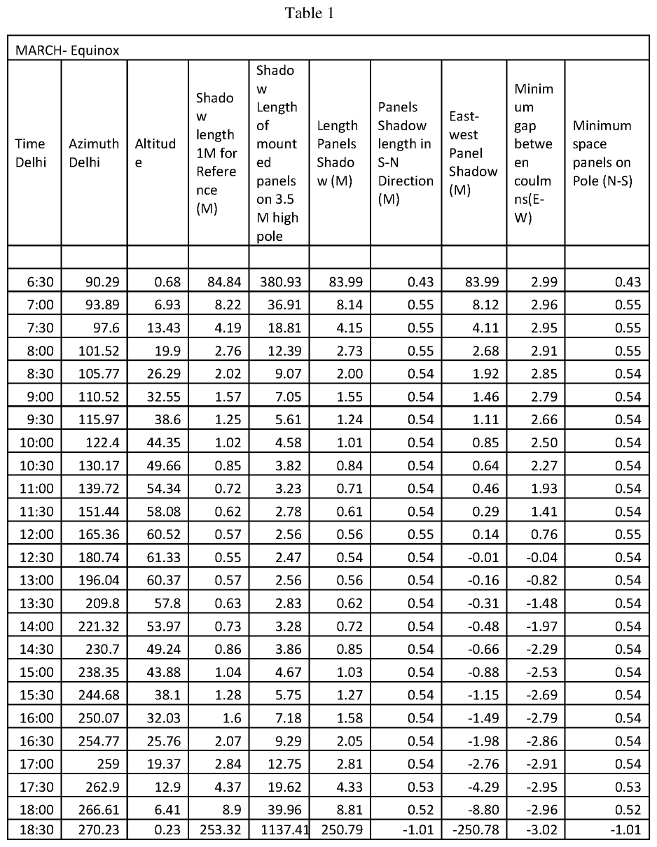

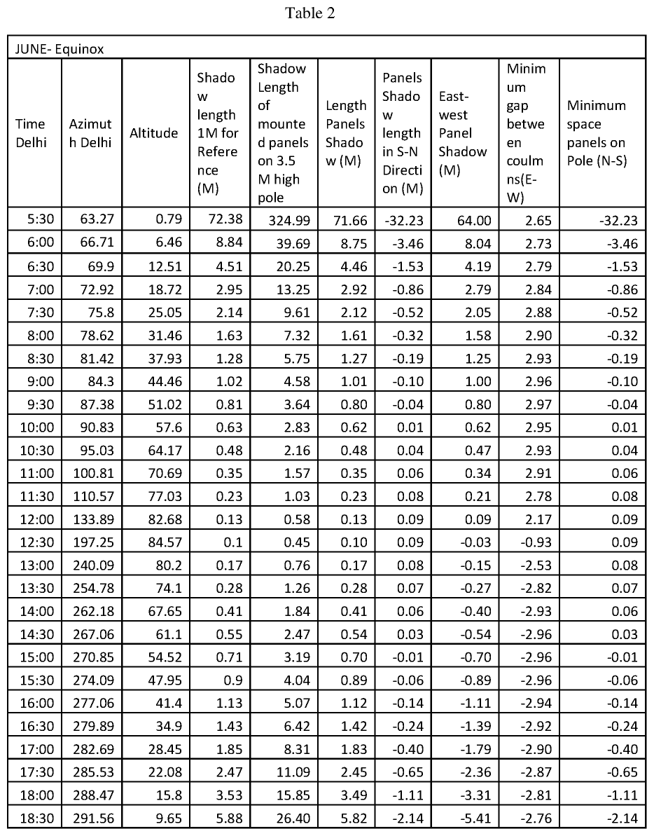

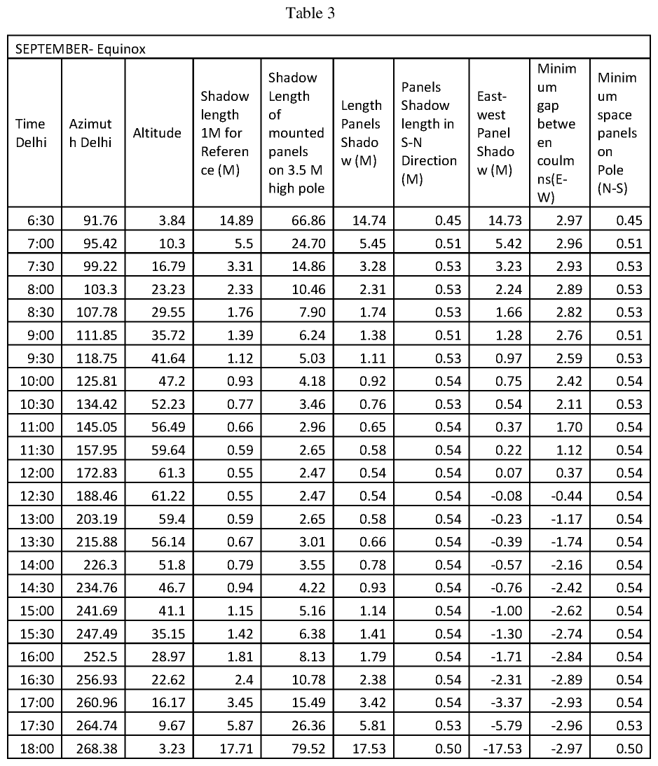

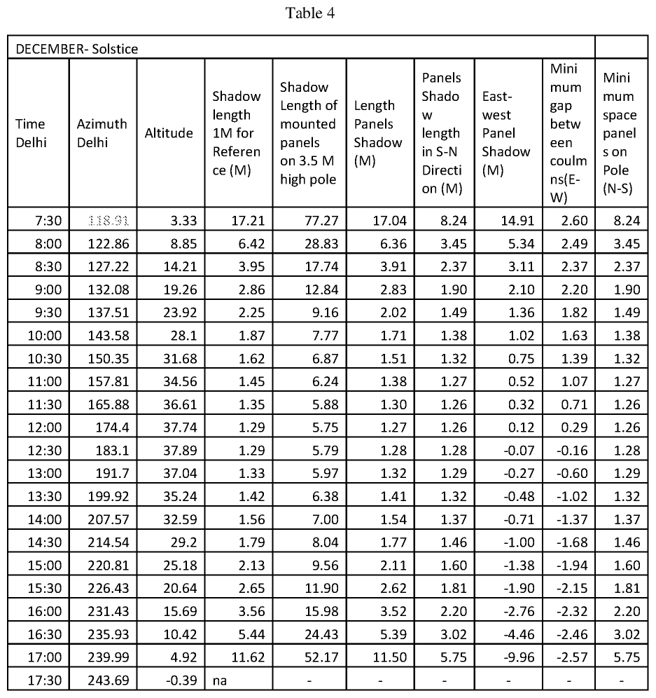

FIG. 8 illustrates the method of distribution of energy to various sectors comprises the following steps:
a. generation of electricity through solar collector/solar panels (101);
b. supplying the energy generated through solar panel to power distribution panel (102);
c. distributing a part of generated supply to National Grid Supply (105) for consumption in various residential or commercial sectors;
d. distributing a part of generated supply to Electric Road Network (110) as per the requirement of the site;
e. distributing another part of generated electricity to electrolyser (111) through DC/DC inverter (107);
f. performing electrolysis of water for separation of oxygen and hydrogen;
g. supplying hydrogen gas obtained from electrolysis to hydrogen storage tank (108) through compressor;
h. distributing hydrogen gas to various sectors as per the requirement;
i. distributing a part of generated hydrogen to hydrogen fuel cells;
j. combining hydrogen and oxygen (received from air) electrochemically in the fuel cells to generate electricity;
k. supplying the generated electricity to the electrical distribution panel for further distribution to various sectors as per requirement;
l. draining the warm distilled water generated in the fuel cells due to electrochemical process to the water tank;
m. purifying the warm water before storing in water tank;
n. pumping the water through pump motor to electrolyser(111) for electrolysis process;
o. supplying oxygen gas obtained from electrolysis to oxygen storage tank (106) through compressor; and
p. distributing oxygen gas to various sectors as per the requirement.

The system discussed in the present invention may be utilized for the following purposes:
The electricity generated by solar collector may be utilized for residential and Industrial use though Grid.
In the existing system due to lack of land availability, systems are progressing towards high capacity in small size. So, every component used are highly sensitive to get better output in small area but in the present invention all land limitations are removed as solar panels could be installed in cultivating land/farming, highways/road sides as well as utilizing for normal purpose. In cultivation land only 0.15% land is occupied by solar panel poles leaving most of land useable.
There is no scarcity of land so large area with low mounting, small capacity, low size, leaving space in panels to avoid wind pressure or snow and easiest way could be adopted for large capacity power generation at low cost. The solar panel need to be modified for economic output.
India's total primary energy demand is about 1135 GW which can be managed by solar panels nearby to end users and the mass storage as Hydrogen could provide a backup solar energy supply in night or cloudy days.
LED bulbs attached at the back of the solar collector would provide suitable illuminance lor suitable growth of plants even in bad weather or insufficient light at very economical cost.
Installation of Solar collectors as per the present invention with mass storage of solar energy as Hydrogen near airport, port, rocket launcher or other major energy using systems, helps in serving direct hydrogen fuel supply for aviation, marine, submarine, rockets without transportation of hydrogen which makes it zero emissions operations.
The pattern of solar panel installation in cultivating land provides dual benefits to lands. Solar panels in cultivating lands generate solar electricity as well as usual farming production. This help in installation of large capacity solar plants in open area covering cultivating/farming lands, unused, hilly, seashore, sideways of roads/Highways without shading to crops or affecting activities at lands for economical production of hydrogen as mass solar energy storage and easy distribution of hydrogen energy to all sectors.(moving or stationary).
Mass Electricity generation by Solar panels with new setup and its storage as Hydrogen in form of chemical energy and regeneration of electricity by fuel cells make it clean sustainable energy source for infinite time period. Its basic source of energy is sun/solar energy and solar panel as convector to electricity, electrolyser to convert in chemical energy to store as Hydrogen and fuel cells to regenerate electricity for use whenever required by any sector in world.
Tapping oxygen under COVID-19 Epidemic condition helps to supply lifesaving gas to treat patient facing low level of oxygen in body at any place worldwide.
The Hydrogen Storage tanks near airport, Port or any heavy hydrogen fuel powered units could be managed by setting up the system of the present invention and directly connecting to refueling stations via gas pipeline of size as per demand at site. Thereby eliminating the requirement of physical transportation of large Hydrogen tankers to refueling stations for different sectors
Promotes direct delivery for hydrogen fuel to delivery points and electricity to end users for 24 hrs uninterrupted supply at very economical cost.
Delivery of Hydrogen fuel directly by gas pipeline (shortest length as per site) for aviation, Marine, Submarine, Racket launchers or any heavy fuel consuming units by installation of hydrogen storage tank nearest to refueling stations.

While this invention has been described in connection with what is presently considered to be the most practical and preferred embodiment, it is to be understood that the invention is not limited to the disclosed embodiments, but, on the contrary, is intended to cover various modifications and equivalent arrangements included within the scope of the appended claims.

1. A system (100) for producing hydrogen from solar energy comprising:
i. a solar energy capturing system (101) producing electrical energy;
ii. a power distribution and management panel (PDMP) (102) for distribution of electrical energy;
iii. a DC to AC inverter (103) converting direct current power supply received from PDMP and transferring alternating current supply to transformer;
iv. a transformer (104) modulating the received power supply;
v. a grid supply (105) supplying power to the residential or commercial sector;
vi. a DC to DC inverter (107) converting the power supply received from PDMP for supplying to an electrolyser (111);
vii. the electrolyser (111) producing oxygen and hydrogen through electrolysis;
viii. an oxygen storage tank (106) storing oxygen generated by electrolyser (111);
ix. an hydrogen storage tank (108) storing hydrogen generated by electrolyser (111);
x. a fuel cells (114) generating electricity through electrochemical process;
xi. a fuel cells power panel (116) supplying electricity to the PDMP (102);
xii. a monitoring and control system (109) for distribution of hydrogen; and
xiii. an Electric Road Network (110) supplying power to electric vehicles;
wherein
i. the solar energy capturing system (101) configured to generate solar energy comprises atleast one pole (201), atleast one pole top (202), a top horizontal beam (203) mounted on the pole (201), atleast one panel support frame (204), and a plurality of solar collector (205);
ii. the plurality of solar collectors (205) configured to be installed in columns in any direction but always facing toward sun in mid-day for any location on Earth (South or North) managing columns to columns gap equal to total width of panels at single arm on pole;
iii. the solar energy capturing system (101) configured to supply an amount of generated electricity to the electrolyser (111) for producing hydrogen and simultaneously transferring surplus energy to Grid Supply (105) and Electric Road Network (110) on demand; and
iv. the fuel cells (114) configured to generate energy from hydrogen for distribution to Electric Road Network or Grid Supply on demand.

2. The system as claimed in claim 2, wherein the panel support frame (204) is positioned on the top of the pole (201) pivoted by the pole top (202) in between and connected on the edges with the horizontal beam (203) to support atleast one solar collector (205) oriented in energy capturing position.

3. The system as claimed in claim 2, wherein the poles (201) are conical in shape and having Base Diameter (206) and Top Diameter (207).

4. The system as claimed in claim 2, wherein a plurality of LEDs is mounted on the back side of solar collector (205) to provide illuminance to the plants nearby.

5. The system as claimed in claim 2, wherein the one pole top (202) is mounted on the top of the pole (201).

6. The system as claimed in claim 2, wherein the water sprinkler is mounted on the top pole (202) to sprinkle water on solar collector and plants nearby.

7. The system as claimed in claim 2, wherein the pole (201) and the top horizontal beam (203) provides support for electrical connectivity to the solar collector.

8. The system as claimed in claim 1, wherein the solar energy capturing system supplies power to electrolyser (111) via power distribution and management panel (102) for electrolysis of water to produce hydrogen.

9. The system as claimed in claim 1, wherein the fuel cells (114) are connected with fuel cells power panel (116) for distribution of generated electricity.

10. The method for distribution of energy via the system as claimed in claim 1 comprises the following steps:
a. generation of electricity through solar collector/solar panels (101);
b. supplying the energy generated through solar panel to power distribution panel (102);
c. distributing a part of generated supply to National Grid Supply (105) for consumption in various residential or commercial sectors;
d. distributing a part of generated supply to Electric Road Network (110) as per the requirement of the site;
e. distributing another part of generated electricity to electrolyser (111) through DC/DC inverter (107);
f. performing electrolysis of water for separation of oxygen and hydrogen;
g. supplying hydrogen gas obtained from electrolysis to hydrogen storage tank (108) through compressor;
h. distributing hydrogen gas to various sectors as per the requirement;
i. distributing a part of generated hydrogen to hydrogen fuel cells;
j. combining hydrogen and oxygen (received from air) electrochemically in the fuel cells to generate electricity;
k. supplying the generated electricity to the electrical distribution panel for further distribution to various sectors as per requirement;
l. draining the warm distilled water generated in the fuel cells due to electrochemical process to the water tank;
m. purifying the warm water before storing in water tank;
n. pumping the water through pump motor to electrolyser(111) for electrolysis process;
o. supplying oxygen gas obtained from electrolysis to oxygen storage tank (106) through compressor; and
p. distributing oxygen gas to various sectors as per the requirement.

11. The method as claimed in claim 1, wherein distribution of hydrogen fuel is directly connected to storage tank to nearest refueling station of aviation, marine, submarine, rocket launchers or high hydrogen fuel consumer.
